(19) United States
(12) Patent Application Publication
(10) Pub. No.: US 2025/0168000 A1
(43) Pub. Date: May 22, 2025

(54) Cryptographic Data Structure Management Across Security Domains

(71) Applicant: WillCo Tech LLC, Akron, OH (US)

(72) Inventor: Marling Engle, Akron, OH (US)

(73) Assignee: WillCo Tech LLC, Akron, OH (US)

(21) Appl. No.: 18/942,987

(22) Filed: Nov. 11, 2024

Related U.S. Application Data
(60) Provisional application No. 63/599,965, filed on Nov. 16, 2023.

(51) Int. Cl. H04L 9/32

(52) U.S. Cl. CPC H04L 9/32

(57) ABSTRACT

Embodiments of the invention include systems and methods for managing cryptographic data structures across security domains. The system may receive, within a first security domain, information indicating a user performed an action. The system may generate, within the first security domain, a first security domain cryptographic data structure that indicates a qualification of the user relating to the action. The first security domain cryptographic data structure may comprise a first data element and a second data element. The system may determine that at least the first data element can be shared across a security boundary with a second security domain. The system may generate a second security domain cryptographic data structure comprising the first data element. The system may transmit the second security domain cryptographic data structure across the security boundary to the second security domain.

### RELATED APPLICATIONS

This application claims priority to U.S. Provisional Patent Application 63/599,965, the entire contents of which is incorporated by reference herein in its entirety.

### TECHNICAL FIELD

Various aspects of the present disclosure relate generally to systems and methods for managing cryptographic data structures across security domains and, more particularly, to systems and methods for enabling digital badges to cross different security domains securely.

### BACKGROUND

Digital badges offer a means for users to display a digital representation of their qualifications and achievements. Such badges are often be shared via online platforms (such as LinkedIn, Indeed, etc.) where other consumers, such as employers, can readily see and understand an individual's skills, leading to increased professional and networking opportunities. Additionally, digital badges usually contain embedded metadata providing details about the issuing organization along with other verifiable information, which aids in enhancing the credibility of the awarded badges. Often times in secure data environments with multiple security domains, digital badges are prevented from being shared across domains due to containing sensitive data that is not intended for public release. There is a need for improved systems that can enable digital badges to cross different security domains while ensuring data security is upheld.

The present disclosure is directed to overcoming one or more of these above-referenced challenges.

### SUMMARY OF THE DISCLOSURE

According to certain aspects of the disclosure, systems, methods, and computer readable memory are disclosed for managing cryptographic data structures across security domains and, more particularly, to systems and methods for enabling digital badges to cross different security domains securely.

Embodiments describing a system for managing cryptographic data structures across a plurality of security domains may be provided herein. In some cases, the system may receive, within a first security domain, information indicating a user performed an action. The information may comprise one or more of the following: a user identifier configured to identify the user; an action identifier configured to identify the action; and a plurality of data elements relating to the action. The plurality of data elements may include at least a first data element and a second data element. The system may generate, within the first security domain, a first security domain cryptographic data structure that indicates a qualification of the user relating to the action. The first security domain cryptographic data structure may comprise both the first data element and the second data element. The system may determine that at least the first data element can be shared across a security boundary with a second security domain. In some cases, the second security domain may be at a different level of security than the first security domain. Based on the determination, the system may generate a second security domain cryptographic data structure comprising the first data element. In some cases, the system may transmit the second security domain cryptographic data structure across the security boundary to the second security domain.

Embodiments of the invention also include one or more methods for implementing the system described above. Additional objects and advantages of the disclosed technology are set forth below, and will be directly apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 depicts an exemplary diagram showing a sequence for managing/transmitting cryptographic data structures across different security domains.

FIG. 2 depicts an exemplary diagram of managing separate instances of cryptographic data structures distributed amongst different security domains.

FIG. 3 depicts a flowchart of an exemplary routine for managing cryptographic data structures across a plurality of security domains.

FIG. 4 depicts an example system that may execute methods described below.

### DETAILED DESCRIPTION

Various aspects of the present disclosure relate generally to managing cryptographic data structures across security domains and, more particularly, to systems and methods for enabling digital badges to cross different security domains securely.

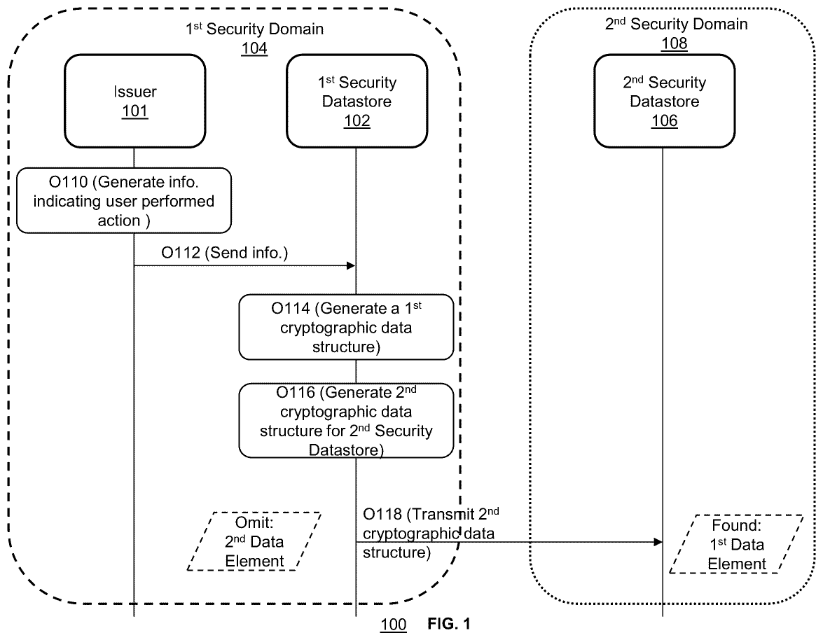

FIG. 1 depicts an exemplary diagram 100 showing a sequence for managing/transmitting cryptographic data structures across different security domains. At operation 110, an issuer 101 may generate information indicating a user performed an action. The information may include one or more of the following: a user identifier configured to identify the user; an action identifier configured to identify the action; and a plurality of data elements relating to the action. The plurality of data elements may include at least a first data element and a second data element.

The issuer 101 (also referred to as issuing authority herein) may be an entity authorized to certify when an individual (the user mentioned above) completes an action in a satisfactory manner. Examples of the action may include any course or program designed to assess a participant's competency in a particular field. Examples of such courses may include at least one or more of the following: project management professional (PMP); certified leadership development professional (CLDP); certified public accountant (CPA) and/or other finance and accounting certifications; language proficiency; healthcare certifications such as certified nursing assistant (CAN); etc. In some embodiments, the information may be generated by the issuer 101 based on the user actively engaging in the course/experience rather than requiring the user to first complete the course before issuing.

At operation 112, the information generated at operation 110 may be sent to a first security datastore 102. In some embodiments, the information may be sent in the form of a file where each of the fields described above are contained within the visible contents of the file. In some embodiments, the file may be integrated with embedded metadata that provides details about the file such as its origin (date/it was issued by the issuer), its contents (details about the actions that were performed such as parameters of the examination), its properties, etc. The information may be verified by the issuer 101 via a digital signature, which may allow any subsequent consumer of the information to know the identity of the issuer 101. The purpose of digitally signing the information, for example, the file, may be to ensure that the contents within remain unchanged from the time of the initial signing. As an example, a file may be generated by an issuer 101 based on determining that a user passed a given course and may contain contents consistent with the generated information described above (e.g., the user identifier, the action identifier, etc.). The file may be hashed into a hash value and then such hash value may be encrypted with a private key of the issuer 101 (attaching a digital signature unique to the issuer 101 to the file). A public key of the issuer 101 may be made available to all potential recipients of the file and can be used to verify the signature and accordingly identify the issuer 101 of the certification.

At operation 114, a first security domain cryptographic data structure may be generated at the first security datastore 102. The first security domain cryptographic data structure may indicate a qualification of the user relating to the action. The first security domain cryptographic data structure may include the first data element and the second data element and, additionally, may have the attached digital signature unique to the issuer 101. In some embodiments, a security domain cryptographic data structure may be any digital form of certification that can be shared and displayed online. An example of a security domain cryptographic data structure may be a digital badge.

In some embodiments, the first security datastore 102 may contain a database that stores records of at least some of the information received from third-party issuers. For example, the records (including the plurality of data elements) may be grouped together at the database based on having matching key values associated with, at least one of, the user identifier and the action identifier. In some embodiments, for an incoming file sent from an issuer 101, a manager of the datastore may determine if a record exists within the database that matches the user identifier contained within the file. If so, the manager may update the existing record with the contents of the incoming file (e.g., add a new performed action listed in the file to the user's record). If no record exists, then the manager may create a record and store it in the database, accordingly. To clarify, each record may pertain to the cryptographic data structures generated based on the received information.

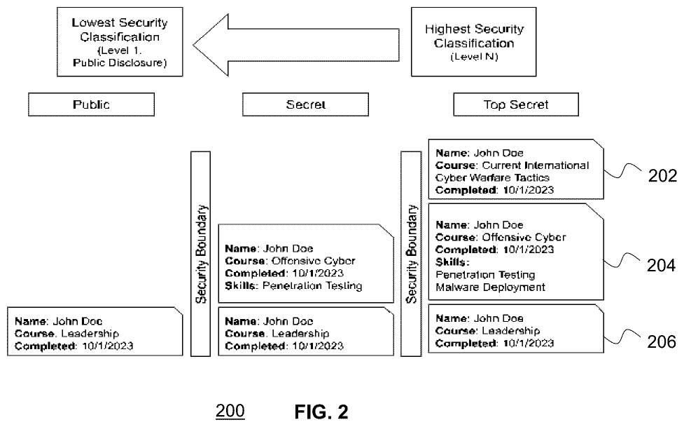

The first security datastore 102 may be contained within a first security domain 104. In some embodiments, the first security domain 104 may be associated with a highest security layer/classification (e.g., the top-secret layer shown in FIG. 2). For example, the first security domain 104 may be configured with a set of advanced security measures/protocols ensuring the data is safe from breaches or other unauthorized access. Such protocols may include firewalls, intrusion detection systems (IDS), heavy encryption for stored and transmitted data, multi-factor authentication (MFA), etc. The different security domains (e.g., the first security domain 104 and the second security domain 108 shown in FIG. 1) may be separated by security boundaries which may consist of logical (defined by software policies) and/or physical devices and networks.

At operation 116, a second security domain cryptographic data structure may be generated within the first security domain 104. The second security domain cryptographic data structure may be generated to be shareable with a security domain configured with a different layer of security, for example, the second security domain 108. For example, the second security domain cryptographic data structure may contain only the data elements from the first security domain cryptographic data structure that can be shared with the second security datastore 106 (hosted on the second security domain 108). In some embodiments, the second security domain cryptographic data structure may be considered a duplicate (e.g., a separate instance/copy of the original digital badge file) of the first security domain cryptographic data structure with restricted data removed/redacted, for example, for being too sensitive to be accessible at the second security domain 108.

In some embodiments, the redaction (which data elements to redact) may be manually selected (cryptographic data structures are targeted individually on a case-by-cases basis by system administrators). In some embodiments, the redaction may be automated based on configured patterns/rules (executed by a configured policy engine designed to observe patterns with which to target redaction). For example, redaction may be performed by comparing data elements, or a field thereof, to a data structure containing a plurality of authorizations indicating types of data elements that can be shared within respective security domains. In some embodiments, the policy engine may consist of one or more rule-based algorithms configured to output whether a given data element can be shared with a given security domain based on one or more rules. In some embodiments, the output of the one or more algorithms may be manually verified/scored, for example, by a system administrator. In some embodiments, instead of redacting sensitive data, other techniques may be used to alter a data element to a state where it can be shared with a lower security domain (e.g., if the data element was an image, then blurring may be sufficient).

The duplicate cryptographic data structures may be generated dynamically or on-demand. For the former, the duplicate cryptographic data structures may be generated at the time the original cryptographic data structure (e.g., the first security domain cryptographic data structure) is generated. These duplicates may adopt the digital signature of the original such that when sent to third-parties, they can be verified as if they were the original. In addition to being wirelessly transmitted to an entity within separate security domain, the duplicate may be stored at the security datastore of original first security domain (where the original cryptographic data structure is stored). In some embodiments, any change/update to the original cryptographic data structure (e.g., a new action has been added to the record) may trigger an update to the duplicate cryptographic data structure. In some embodiments, the updated duplicate may be queued for dispatch to the second security domain 108 and, upon receipt, the duplicate existing at the second security domain 108 may be replaced with the updated version. This may result in the contents of the duplicate cryptographic data structures being synchronized with one another as well as with the original. As for the on-demand embodiment, the duplicate may be generated after the system receives a prompt, for example, a triggering event or a policy change.

At operation 118, the second security domain cryptographic data structure (also referred to as the duplicate cryptographic data structure herein) may be transmitted to the second security datastore 106 located on the second security domain 108. As shown, the datastore 106 may only retrieve the first data element as the second data element was omitted based on being too sensitive to be shared on the second security domain 108.

In some embodiments, a cross-domain device may be disposed at a boundary between a first security domain 104 and a second security domain 108. The cross-domain may determine (based on reading embedded metadata) that a cryptographic data structure attempting to transgress from a high security domain (first security domain 104) to a low security domain (second security domain 108) comprises information that is not authorized to be shared within the low security domain. Based on the determination, the device may prevent the cryptographic data structure (e.g., the entire cryptographic data structure) from crossing the boundary from the first security domain 104 to the second security domain 108. Such determination may be performed logically (from a single software system determining which destination zone is intended), physically (with an appliance designed to pass data between security domains with an entry point in each domain), or virtually (similar to physical embodiment but with a virtual appliance).

FIG. 2 depicts an exemplary diagram 200 of managing separate instances of cryptographic data structures distributed amongst different security domains. As shown, a user identifier may be “John Doe” and this user may perform three separate actions (or as shown “courses”): a current international cyber warfare tactics course 202, an offensive cyber course 204, and a leadership course 206. As for the first course 202, the system may determine that no content (e.g., data elements) can be shared outside of the highest security zone (“top-secret” layer). In some embodiments, the policy engine may identify the hyper-sensitive nature of the course and deem all content (or skills) pertaining to the course as not shareable. As for the offensive action course 204, the system may determine that the penetration testing skill (which can be thought of as data element 1 from FIG. 1) can be to be shared with a security domain located within the secret security layer but cannot be shared on a repository of the public domain. Additionally, the system may redact the malware deployment skill (which can be thought of as data element 2 from FIG. 1). As for the leadership course 206, the system may determine that such a skill can be shared at all three security layers. In some cases, the system may determine that at least some skills (data elements) can be shared across a security boundary with a third security domain. For example, the third security domain may be configured with a level of lower security than the second security domain (which may be configured with a level of lower security than the first security domain). A number of data elements that are shareable with the third security domain may be less than a number data elements that are shareable with the second security. In some cases, the third security domain may index the cryptographic data structure on a public repository such that members of the public can access content of the cryptographic data structure.

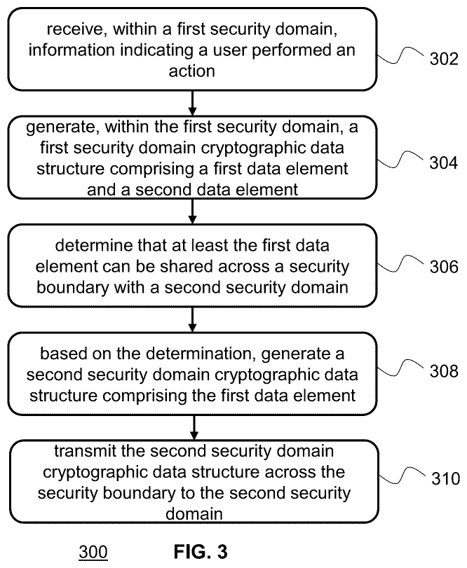

FIG. 3 depicts a flowchart of an exemplary routine 300 for managing cryptographic data structures across a plurality of security domains. In the routine 300, the method may be performed by one or more systems as described above. The routine 300 starts at step 302, where the system may receive, within a first security domain, information indicating a user performed an action. The information may comprise one or more of the following: a user identifier configured to identify the user; an action identifier configured to identify the action; and a plurality of data elements relating to the action. The plurality of data elements may include at least a first data element and a second data element. In some cases, the plurality of data elements may be records within at least one database. The records may be grouped together based on having matching key values associated with, at least one of, the user identifier and the action identifier. In some cases, the action may relate to a competency of the user in a particular area of expertise. The information indicating the user performed the action may be received from an issuing authority. At step 304, the system may generate, within the first security domain, a first security domain cryptographic data structure that indicates a qualification of the user relating to the action. The first security domain cryptographic data structure may comprise both the first data element and the second data element. At step 306, the system may determine that at least the first data element can be shared across a security boundary with a second security domain. In some cases, the second security domain may be at a different level of security than the first security domain. In some cases, determining that the first data element can be shared across the security boundary with the second security domain may involve the system comparing the first data element, or a field thereof, to a data structure containing a plurality of authorizations indicating types of data elements that can be shared within respective security domains. At step 308, based on the determination, the system may generate a second security domain cryptographic data structure comprising the first data element. In some cases, the second security domain cryptographic data structure may be generated after the system receives a prompt, for example, a triggering event or a policy change described above. At step 310, the system may transmit the second security domain cryptographic data structure across the security boundary to the second security domain. In some cases, the system may be further configured to determine that the second data element is not authorized to be shared across the security boundary to the second security domain. In such a case, generating the second security domain cryptographic data structure may involve the system causing the second security domain cryptographic data structure to comprise the first data element but to omit the second data element. In some cases, the first security domain may be isolated from the second security domain. In such a case, transmitting the second security domain cryptographic data structure across the security boundary to the second security domain may involve transmitting the second security domain cryptographic data structure to a cross-domain device that is configured to assess whether information can be shared between the first security domain and the second security domain.

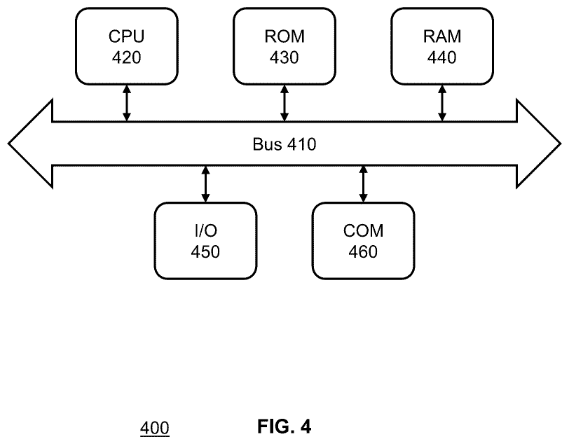

FIG. 4 depicts an example system, including a computer, that may execute one or more embodiments of the invention. Specifically, the computer (or “platform” as it may not be a single physical computer infrastructure) may include a data communication interface 460 for packet data communication. The platform may also include a central processing unit (“CPU”) 420, in the form of one or more processors, for executing program instructions. The platform may include an internal communication bus 410, and the platform may also include a program storage and/or a data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer. Those skilled in the relevant art will appreciate that aspects of the present disclosure can be practiced with other communications, data processing, or computer system configurations.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure are stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure are distributed over the Internet and/or over other networks, including wireless networks, on a propagated signal on a propagation medium (e.g., an electromagnetic wave(s), a sound wave, etc.) over a period of time, and/or they may be provided on any analog or digital network (i.e., packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of +10% in a stated value.

The term “exemplary” is used in the sense of “example” rather than “ideal.” As used herein, the singular forms “a,” “an,” and “the” include plural reference unless the context dictates otherwise.

### Examples

Exemplary embodiments of the systems and methods disclosed herein are described in the numbered paragraphs below.

A1. A system for managing cryptographic data structures across a plurality of security domains, the system comprising:
a processing unit comprising one or more processors;
a memory unit storing computer-readable instructions, wherein the system is configured to:
receive, within a first security domain, information indicating a user performed an action, wherein the information comprises: a user identifier configured to identify the user, an action identifier configured to identify the action, and a plurality of data elements relating to the action, the plurality of data elements comprising at least a first data element and a second data element;
generate, within the first security domain, a first security domain cryptographic data structure that indicates a qualification of the user relating to the action, the first
determine that at least the first data element can be shared across a security boundary with a second security domain, wherein the second security domain is at a different level of security than the first security domain;
based on the determination, generate a second security domain cryptographic data structure comprising the first data element; and
transmit the second security domain cryptographic data structure across the security boundary to the second security domain.

A2. The system of claim A1, wherein the system is further configured to determine that the second data element is not authorized to be shared across the security boundary to the second security domain; and generating the second security domain cryptographic data structure comprises causing the second security domain cryptographic data structure to comprise the first data element but to omit the second data element.

A3. The system of claims A1-A2, wherein the plurality of data elements are records within at least one database, wherein the records are grouped together based on having matching key values associated with, at least one of, the user identifier and the action identifier.

A4. The system of claims A1-A3, wherein determining that the first data element can be shared across the security boundary with the second security domain comprises comparing the first data element, or a field thereof, to a data structure containing a plurality of authorizations indicating types of data elements that can be shared within respective security domains.

A5. The system of claims A1-A4, wherein the action relates to a competency of the user in a particular area of expertise, and wherein the information indicating the user performed the action is received from an issuing authority.

A6. The system of claims A1-A5, wherein the system is further configured to determine that at least some of the plurality of data elements can be shared across a security boundary with a third security domain, wherein the third security domain is configured with a level of lower security than the second security domain, wherein a number of data elements that are shareable with the third security domain is less than a number data elements that are shareable with the second security domain.

A7. The system of claims A1-A6, wherein the first security domain is isolated from the second security domain, and transmitting the second security domain cryptographic data structure across the security boundary to the second security domain comprises transmitting the second security domain cryptographic data structure to a cross-domain device that is configured to assess whether information can be shared between the first security domain and the second security domain.

A8. The system of claims A1-A7, wherein the third security domain indexes the cryptographic data structure on a public repository such that members of the public can access content of the cryptographic data structure.

A9. The system of claims A1-A8, wherein the system is further configured to:
generate, within the first security domain, the first security domain cryptographic data structure that indicates a qualification of the user relating to the action, the first
after the first security domain cryptographic data structure is generated:
   receive a prompt to generate the second security domain cryptographic to be shared across the security boundary with the second security domain; and
   in response to the prompt, generate the second security domain cryptographic.

B1. A method for managing cryptographic data structures across a plurality of security domains, the method comprising:
receiving, within a first security domain, information indicating a user performed an action, wherein the information comprises: a user identifier configured to identify the user, an action identifier configured to identify the action, and a plurality of data elements relating to the action, the plurality of data elements comprising at least a first data element and a second data element;
generating, within the first security domain, a first security domain cryptographic data structure that indicates a qualification of the user relating to the action, the first security domain cryptographic data structure comprising both the first data element and the second data element;
determining that at least the first data element can be shared across a security boundary with a second security domain, wherein the second security domain is at a different level of security than the first security domain;
based on the determination, generating a second security domain cryptographic data structure comprising the first data element; and
transmitting the second security domain cryptographic data structure across the security boundary to the second security domain.

B2. The method of B1, wherein further comprising any combination of steps in A2-A9.

C1. A system for managing cryptographic data structures across a plurality of security domains, the system comprising:
a processing unit comprising one or more processors, the processing unit being disposed at a boundary between a first security domain and a second security domain, the first security domain being at a higher level of security than the second security domain;
a memory unit storing computer-readable instructions, wherein the system is configured to:
receive, from a device within the first security domain, a cryptographic data structure indicating that indicates a qualification of a user relating to an action;
determine that the cryptographic data structure comprises information that is not authorized to be shared within the second security domain; and
based on the determination, prevent the cryptographic data structure from crossing the boundary from the first security domain to the second security domain.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

1. A system for managing cryptographic data structures across a plurality of security domains, the system comprising:
a processing unit comprising one or more processors;
a memory unit storing computer-readable instructions, wherein the system is configured to:
receive, within a first security domain, information indicating a user performed an action, wherein the information comprises: a user identifier configured to identify the user, an action identifier configured to identify the action, and a plurality of data elements relating to the action, the plurality of data elements comprising at least a first data element and a second data element;
generate, within the first security domain, a first security domain cryptographic data structure that indicates a qualification of the user relating to the action, the first security domain cryptographic data structure comprising both the first data element and the second data element;
determine that at least the first data element can be shared across a security boundary with a second security domain, wherein the second security domain is at a different level of security than the first security domain;
based on the determination, generate a second security domain cryptographic data structure comprising the first data element; and
transmit the second security domain cryptographic data structure across the security boundary to the second security domain.

2. The system of claim 1, wherein the system is further configured to determine that the second data element is not authorized to be shared across the security boundary to the second security domain; and generating the second security domain cryptographic data structure comprises causing the second security domain cryptographic data structure to comprise the first data element but to omit the second data element.

3. The system of claim 1, wherein the plurality of data elements are records within at least one database, wherein the records are grouped together based on having matching key values associated with, at least one of, the user identifier and the action identifier.

4. The system of claim 1, wherein determining that the first data element can be shared across the security boundary with the second security domain comprises comparing the first data element, or a field thereof, to a data structure containing a plurality of authorizations indicating types of data elements that can be shared within respective security domains.

5. The system of claim 1, wherein the action relates to a competency of the user in a particular area of expertise, and wherein the information indicating the user performed the action is received from an issuing authority.

6. The system of claim 1, wherein the system is further configured to determine that at least some of the plurality of data elements can be shared across a security boundary with a third security domain, wherein the third security domain is configured with a level of lower security than the second security domain, wherein a number of data elements that are shareable with the third security domain is less than a number data elements that are shareable with the second security domain.

7. The system of claim 1, wherein the first security domain is isolated from the second security domain, and transmitting the second security domain cryptographic data structure across the security boundary to the second security domain comprises transmitting the second security domain cryptographic data structure to a cross-domain device that is configured to assess whether information can be shared between the first security domain and the second security domain.

8. The system of claim 6, wherein the third security domain indexes the cryptographic data structure on a public repository such that members of the public can access content of the cryptographic data structure.

9. The system of claim 1, wherein the system is further configured to:
generate, within the first security domain, the first security domain cryptographic data structure that indicates a qualification of the user relating to the action, the first security domain cryptographic data structure comprising both the first data element and the second data element;
after the first security domain cryptographic data structure is generated:
receive a prompt to generate the second security domain cryptographic data structure to be shared across the security boundary with the second security domain; and
in response to the prompt, generate the second security domain cryptographic.

10. A method for managing cryptographic data structures across a plurality of security domains, the method comprising:
receiving, within a first security domain, information indicating a user performed an action, wherein the information comprises: a user identifier configured to identify the user, an action identifier configured to identify the action, and a plurality of data elements relating to the action, the plurality of data elements comprising at least a first data element and a second data element;
generating, within the first security domain, a first security domain cryptographic data structure that indicates a qualification of the user relating to the action, the first security domain cryptographic data structure comprising both the first data element and the second data element;
determining that at least the first data element can be shared across a security boundary with a second security domain, wherein the second security domain is at a different level of security than the first security domain;
based on the determination, generating a second security domain cryptographic data structure comprising the first data element; and
transmitting the second security domain cryptographic data structure across the security boundary to the second security domain.

11. The method of 10, further comprising:
determining that the second data element is not authorized to be shared across the security boundary to the second security domain; and
wherein generating the second security domain cryptographic data structure comprises causing the second security domain cryptographic data structure to comprise the first data element but to omit the second data element.

12. The method of claim 10, wherein the plurality of data elements are records within at least one database, wherein the records are grouped together based on having matching key values associated with, at least one of, the user identifier and the action identifier.

13. The method of claim 10, wherein determining that the first data element can be shared across the security boundary with the second security domain comprises comparing the first data element, or a field thereof, to a data structure containing a plurality of authorizations indicating types of data elements that can be shared within respective security domains.

14. The method of claim 10, wherein the action relates to a competency of the user in a particular area of expertise, and wherein the information indicating the user performed the action is received from an issuing authority.

15. The method of claim 10, further comprising:
determining that at least some of the plurality of data elements can be shared across a security boundary with a third security domain, wherein the third security domain is configured with a level of lower security than the second security domain, wherein a number of data elements that are shareable with the third security domain is less than a number data elements that are shareable with the second security domain.

16. The method of claim 10, wherein the first security domain is isolated from the second security domain, and transmitting the second security domain cryptographic data structure across the security boundary to the second security domain comprises transmitting the second security domain cryptographic data structure to a cross-domain device that is configured to assess whether information can be shared between the first security domain and the second security domain.

17. The method of claim 15, wherein the third security domain indexes the cryptographic data structure on a public repository such that members of the public can access content of the cryptographic data structure.

18. The method of claim 10, further comprising:
generating, within the first security domain, the first security domain cryptographic data structure that indicates a qualification of the user relating to the action, the first security domain cryptographic data structure comprising both the first data element and the second data element;
after the first security domain cryptographic data structure is generated:
receiving a prompt to generate the second security domain cryptographic to be shared across the security boundary with the second security domain; and
in response to the prompt, generating the second security domain cryptographic.

19. A system for managing cryptographic data structures across a plurality of security domains, the system comprising:
a processing unit comprising one or more processors, the processing unit being disposed at a boundary between a first security domain and a second security domain, the first security domain being at a higher level of security than the second security domain;
a memory unit storing computer-readable instructions, wherein the system is configured to:
receive, from a device within the first security domain, a cryptographic data structure indicating that indicates a qualification of a user relating to an action;
determine that the cryptographic data structure comprises information that is not authorized to be shared within the second security domain; and
based on the determination, prevent the cryptographic data structure from crossing the boundary from the first security domain to the second security domain.
